(19) United States
(12) Patent Application Publication
(10) Pub. No.: US 2018/0240076 A1
(43) Pub. Date: Aug. 23, 2018

(54) CALENDAR MANAGEMENT DEVICES AND METHODS FOR CONTROLLING A CALENDAR MANAGEMENT DEVICE

(71) Applicant: RAZER (ASIA-PACIFIC) PTE. LTD., SINGAPORE (SG)

(72) Inventor: Sugiharta Arsadi Thio, Singapore (SG)

(21) Appl. No.: 15/743,172

(22) PCT Filed: Jul. 9, 2015
(86) PCT No.: PCT/SG2015/050208

§ 371 Date: Jan. 9, 2018

(51) Int. Cl. G06Q 10/10; G10L 15/08; G10L 15/22; G10L 15/26

(52) U.S. Cl. CPC G06Q 10/1095; G10L 15/08; G06F 1/163; G10L 15/265; G10L 2015/088; G10L 15/22

(57) ABSTRACT

According to various embodiments, a calendar management device may be provided. The calendar management device may include: an appointment storage configured to store information related to at least one appointment; a conversation processing circuit configured to analyze information of a conversation; a calendar querying circuit configured to query the appointment storage based on an output of the conversation processing circuit; and a feedback circuit configured to provide feedback to a user of the calendar management device based on an output of the calendar querying circuit.

### TECHNICAL FIELD

Various embodiments generally relate to calendar management devices and methods for controlling a calendar management device.

### BACKGROUND

A lot of people get busier and busier. Thus, there may be a need for efficient management of appointments.

### SUMMARY OF THE INVENTION

According to various embodiments, a calendar management device may be provided. The calendar management device may include: an appointment storage configured to store information related to at least one appointment; a conversation processing circuit configured to analyze information of a conversation; a calendar querying circuit configured to query the appointment storage based on an output of the conversation processing circuit; and a feedback circuit configured to provide feedback to a user of the calendar management device based on an output of the calendar querying circuit.

According to various embodiments, a method for controlling a calendar management device may be provided. The method may include: storing information related to at least one appointment in an appointment storage; analyzing information of a conversation; querying the appointment storage based on the analyzing; and providing feedback to a user of the calendar management device based on the querying.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1 shows a calendar management device according to various embodiments; and

FIG. 2 shows a flow diagram illustrating a method for controlling a calendar management device according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

In this context, the calendar management device as described in this description may include a memory which is for example used in the processing carried out in the calendar management device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

The reference to any prior art in this specification is not, and should not be taken as an acknowledgement or any form of suggestion that the referenced prior art forms part of the common general knowledge in Australia (or any other country).

In order that the invention may be readily understood and put into practical effect, particular embodiments will now be described by way of examples and not limitations, and with reference to the figures.

Various embodiments are provided for devices, and various embodiments are provided for methods. It will be understood that basic properties of the devices also hold for the methods and vice versa. Therefore, for sake of brevity, duplicate description of such properties may be omitted.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed or attached, or just in contact without any fixation, and it will be understood that both direct coupling or indirect coupling (in other words: coupling without direct contact) may be provided.

A lot of people get busier and busier.

It will be understood that almost everyone may have been in a situation where he has been in a discussion or conversation or a meeting where suddenly the meeting ends with another meeting request by the participant. For example a busy person may be asked if he is free for a dinner tomorrow and the busy person may wonder if he is free and may have to take out his phone or organizer and check the calendar for his schedule.

According to various embodiments, efficient management of appointments may be provided.

There are people who have to fumble their phones and organizer to check their busy schedules, and the parties involved may have to spend time to negotiate when to meet up and sometimes they can't reach an agreement and have to back to shift things around and get back at the person again. According to various embodiments, devices and methods may be provided which help those people to quickly set up the meeting, like a personal assistant, but in a user's pocket or wearable.

Devices and methods according to various embodiments may provide help for deciding much faster as though the devices or methods may listen to a conversation and when during the conversation a person is asked (for example for an appointment), and the devices or methods may suggest an available time automatically.

According to various embodiments, a voice context recognition schedule maker may be provided. According to various embodiments, a schedule suggestor (which for example may be referred to or may be called “Am I Free?”) may be provided.

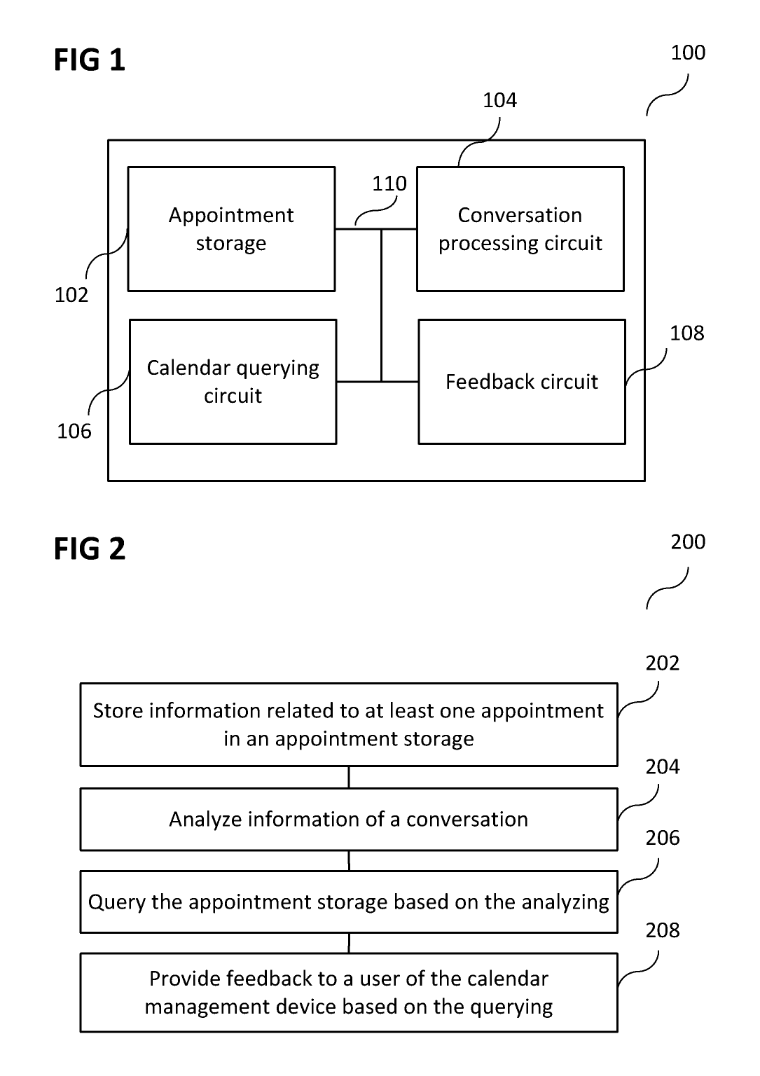

FIG. 1 shows a calendar management device 100 according to various embodiments. The calendar management device 100 may include an appointment storage 102 (in other words: appointment memory) configured to store information related to at least one appointment. The appointment storage 102 may include a calendar (for example stored in a computing device, for example a mobile radio communication device), or the appointment storage 102 may include partial calendar information (for example received in a wearable device from a computing device). The calendar management device 100 may further include a conversation processing circuit 104 configured to analyze information of a conversation. The calendar management device 100 may further include a calendar querying circuit 106 configured to query the appointment storage based on an output of the conversation processing circuit 104 (for example, if the appointment storage includes the calendar, the calendar querying circuit 106 may directly query (or parse) the calendar; for example, if the appointment storage includes partial calendar information, the calendar querying circuit 106 may analyze the partial calendar information (which may for example include information indicating whether the calendar includes an appointment at a certain time)). The calendar management device 100 may further include a feedback circuit 108 configured to provide feedback to a user of the calendar management device 100 based on an output of the calendar querying circuit 106. The appointment storage 102, the conversation processing circuit 104, the calendar querying circuit 106, and the feedback circuit 108 may be coupled with each other, like indicated by lines 110, for example electrically coupled, for example using a line or a cable, and/or mechanically coupled.

In other words, according to various embodiments, a calendar management device may listen to a conversation (or may read a conversation), and may provide feedback to a user of the calendar management device based on the conversation and based on calendar information.

According to various embodiments, the information related to the at least one appointment may include or may be time information for the at least one appointment.

According to various embodiments, the conversation may include or may be at least one of a spoken conversation or a written conversation.

According to various embodiments, the conversation processing circuit 104 may include a microphone.

According to various embodiments, the conversation processing circuit 104 may be configured to determine whether the conversation includes a pre-determined keyword.

According to various embodiments, the conversation processing circuit 104 may be configured to determine whether the conversation includes a request for an appointment.

According to various embodiments, the conversation processing circuit 104 may be configured to determine whether the conversation includes time information related to the request for the appointment.

According to various embodiments, the calendar querying circuit 106 may be configured to determine whether the appointment storage 102 includes an appointment at least partially overlapping with the time information related to the request for the appointment.

According to various embodiments, the feedback circuit 108 may be configured to provide feedback indicating approval of the request for the appointment if the calendar querying circuit 106 determines that the appointment storage 102 does not include an appointment at least partially overlapping with the time information related to the request for the appointment.

According to various embodiments, the feedback circuit 108 may be configured to provide feedback indicating an alternative timing if the calendar querying circuit 106 determines that the appointment storage 102 includes an appointment at least partially overlapping with the time information related to the request for the appointment.

According to various embodiments, the feedback circuit 108 may be configured to provide at least one of visual feedback or acoustic feedback.

According to various embodiments, the calendar management device 100 may include or may be or may be included in a wearable device.

According to various embodiments, the wearable device 100 may include or may be or may be included in a wristband.

According to various embodiments, the appointment storage 102 may be configured to store information related to at least one appointment, the information received from a radio communication device (not shown in FIG. 1).

According to various embodiments, the wearable device 100 may include or may be or may be included in a mobile radio communication device.

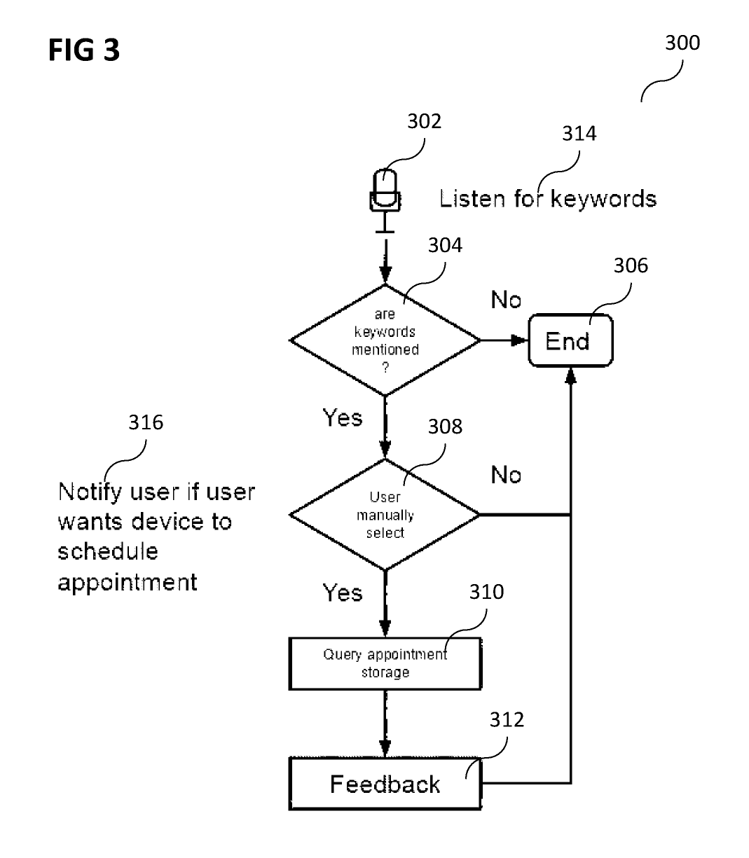

FIG. 2 shows a flow diagram 200 illustrating a method for controlling a calendar management device according to various embodiments. In 202 information related to at least one appointment may be stored in an appointment storage. In 204, information of a conversation may be analyzed. In 206, the appointment storage may be queried based on the analyzing. In 208, feedback may be provided to a user of the calendar management device based on the querying.

According to various embodiments, the information related to the at least one appointment may include or may be time information for the at least one appointment.

According to various embodiments, the conversation may include or may be at least one of a spoken conversation or a written conversation.

According to various embodiments, the conversation may be analyzed based on an output of a microphone.

According to various embodiments, the method may further include determining whether the conversation includes a pre-determined keyword.

According to various embodiments, the method may further include determining whether the conversation includes a request for an appointment.

According to various embodiments, the method may further include determining whether the conversation includes time information related to the request for the appointment.

According to various embodiments, the method may further include determining whether the appointment storage includes an appointment at least partially overlapping with the time information related to the request for the appointment.

According to various embodiments, the method may further include providing feedback indicating approval of the request for the appointment if it is determined that the appointment storage does not include an appointment at least partially overlapping with the time information related to the request for the appointment.

According to various embodiments, the method may further include providing feedback indicating an alternative timing if it is determined that the appointment storage includes an appointment at least partially overlapping with the time information related to the request for the appointment.

According to various embodiments, the method may further include providing at least one of visual feedback or acoustic feedback.

According to various embodiments, the calendar management device may include or may be or may be included in a wearable device.

According to various embodiments, the wearable device may include or may be or may be included in a wristband.

According to various embodiments, the appointment storage may be configured to store information related to at least one appointment received from a radio communication device.

According to various embodiments, the wearable device may include or may be or may be included in a mobile radio communication device.

According to various embodiments, for example a smartwatch or smartband may be listening to all of a user's conversation and may notify the user on its display (or for example via optional sound dictation), for example with a message similar like this: “Hey [insert your name], you are not free tomorrow from 6 pm to 8 pm, but you are free the day after from 6 pm to 8 pm”.

According to various embodiments, devices and methods may listen automatically and/or proactively and may provide feedback with context.

According to various embodiments, devices and methods may be provided for quickly checking a calendar of a user for availability of the user and may suggest the next possible free time if the user is busy by listening to a conversation and listening for words that ask about the user's schedule.

FIG. 3 shows a flow diagram 300 illustrating a calendar management method (in other words: a method for managing a calendar management device) according to various embodiments.

Like indicated by 314, a calendar management device may listen for keywords, for example using a microphone 302 (which may be included in the calendar management device, or which may be a microphone external to the calendar management device). In 304, it may be determined whether keywords are mentioned in a conversation. If keywords are not mentioned, then processing may proceed in 306. In 306, the processing may be ended or the processing may be restarted by keeping on listening to the conversation (or determining whether there is a conversation, and if it is determined that there is a conversation, listening to the conversation; if it is determined that there is no conversation, the processing may pause for a pre-determined period (for example 5 seconds, 30 seconds, 1 minute, or any other suitable time), which may save energy; it will be understood that the pre-determined period may be set so that energy can be save, but at the same time, the chance of missing a conversation or a keyword in the conversation may be limited).

If it is determined in 304 that a keyword is present, then processing may proceed in 308. In 308, a user may be requested to approve the calendar management device to query an appointment storage. If the users rejects in 308, processing may proceed in 306. If the user approves in 308, processing may proceed in 310.

In 310, the appointment storage may be queried, and the result of the query may be fed back to the user in 312.

Like indicated by 316, a user may be notified is the user wants the calendar management device to schedule an appointment.

In other words, the (calendar management) device may listen to a conversation when the device is worn and voice is recognized within range (which may provide energy saving measures), but it may not (directly) activate the query. When the device recognizes keywords such as ‘meetings’, ‘meet up’, ‘appointment’, ‘session’, ‘schedule’ (wherein the keywords may be programmable), the device may then feedback to a user and wait for the user to approve the device to start query on appointment storage.

According to various embodiments, a voice context recognition scheduling device (or method, or application (which may also be referred to as app)) may be provided. The device or method or application may include a voice recognition circuit or method that may integrate into a smartphone or smartwatch. The device, method or app may proactively listen in to a conversation. When mention of a scheduling is made, the device, method or application may inject with a reminder or recommendation related to scheduling. The device, method or application may do this because it may be operatively connected to a user's predetermined calendars. Various embodiments may automate scheduling and may eliminate the need to search multiple calendars to review a calendar. According to various embodiments, a device, method or (software) application that proactively listens in to a conversation may be provided. When mention of a scheduling is made, the device, method or app may inject with a reminder or recommendation related to scheduling.

The following examples pertain to further embodiments.

Example 1 is a calendar management device comprising: an appointment storage configured to store information related to at least one appointment; a conversation processing circuit configured to analyze information of a conversation; a calendar querying circuit configured to query the appointment storage based on an output of the conversation processing circuit; and a feedback circuit configured to provide feedback to a user of the calendar management device based on an output of the calendar querying circuit.

In example 2, the subject-matter of example 1 can optionally include that the information related to the at least one appointment comprises time information for the at least one appointment.

In example 3, the subject-matter of any one of examples 1 to 2 can optionally include that the conversation comprises at least one of a spoken conversation or a written conversation.

In example 4, the subject-matter of any one of examples 1 to 3 can optionally include that the conversation processing circuit comprises a microphone.

In example 5, the subject-matter of any one of examples 1 to 4 can optionally include that the conversation processing circuit is configured to determine whether the conversation comprises a pre-determined keyword.

In example 6, the subject-matter of any one of examples 1 to 5 can optionally include that the conversation processing circuit is configured to determine whether the conversation comprises a request for an appointment.

In example 7, the subject-matter of example 6 can optionally include that the conversation processing circuit is configured to determine whether the conversation comprises time information related to the request for the appointment.

In example 8, the subject-matter of example 7 can optionally include that the calendar querying circuit is configured to determine whether the appointment storage comprises an appointment at least partially overlapping with the time information related to the request for the appointment.

In example 9, the subject-matter of example 8 can optionally include that the feedback circuit is configured to provide feedback indicating approval of the request for the appointment if the calendar querying circuit determines that the appointment storage does not comprise an appointment at least partially overlapping with the time information related to the request for the appointment.

In example 10, the subject-matter of any one of examples 8 to 9 can optionally include that the feedback circuit is configured to provide feedback indicating an alternative timing if the calendar querying circuit determines that the appointment storage comprises an appointment at least partially overlapping with the time information related to the request for the appointment.

In example 11, the subject-matter of any one of examples 1 to 10 can optionally include that the feedback circuit is configured to provide at least one of visual feedback or acoustic feedback.

In example 12, the subject-matter of any one of examples 1 to 11 can optionally include that the calendar management device comprises a wearable device.

In example 13, the subject-matter of any one of examples 1 to 12 can optionally include that the wearable device comprises a wristband.

In example 14, the subject-matter of any one of examples 1 to 13 can optionally include that the appointment storage is configured to store information related to at least one appointment received from a radio communication device.

In example 15, the subject-matter of any one of examples 1 to 14 can optionally include that the wearable device comprises a mobile radio communication device.

Example 16 is a method for controlling a calendar management device, the method comprising: storing information related to at least one appointment in an appointment storage; analyzing information of a conversation; querying the appointment storage based on the analyzing; and providing feedback to a user of the calendar management device based on the querying.

In example 17, the subject-matter of example 16 can optionally include that the information related to the at least one appointment comprises time information for the at least one appointment.

In example 18, the subject-matter of any one of examples 16 to 17 can optionally include that the conversation comprises at least one of a spoken conversation or a written conversation.

In example 19, the subject-matter of any one of examples 16 to 18 can optionally include that the conversation is analyzed based on an output of a microphone.

In example 20, the subject-matter of any one of examples 16 to 19 can optionally include determining whether the conversation comprises a pre-determined keyword.

In example 21, the subject-matter of any one of examples 16 to 20 can optionally include determining whether the conversation comprises a request for an appointment.

In example 22, the subject-matter of example 21 can optionally include determining whether the conversation comprises time information related to the request for the appointment.

In example 23, the subject-matter of example 22 can optionally include determining whether the appointment storage comprises an appointment at least partially overlapping with the time information related to the request for the appointment.

In example 24, the subject-matter of example 23 can optionally include providing feedback indicating approval of the request for the appointment if it is determined that the appointment storage does not comprise an appointment at least partially overlapping with the time information related to the request for the appointment.

In example 25, the subject-matter of any one of examples 23 to 24 can optionally include providing feedback indicating an alternative timing if it is determined that the appointment storage comprises an appointment at least partially overlapping with the time information related to the request for the appointment.

In example 26, the subject-matter of any one of examples 16 to 25 can optionally include providing at least one of visual feedback or acoustic feedback.

In example 27, the subject-matter of any one of examples 16 to 26 can optionally include that the calendar management device comprises a wearable device.

In example 28, the subject-matter of any one of examples 16 to 27 can optionally include that the wearable device comprises a wristband.

In example 29, the subject-matter of any one of examples 16 to 28 can optionally include that the appointment storage is configured to store information related to at least one appointment received from a radio communication device.

In example 30, the subject-matter of any one of examples 16 to 29 can optionally include that the wearable device comprises a mobile radio communication device.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A calendar management device comprising:
an appointment storage configured to store information related to at least one appointment;
a voice recognition circuit configured to recognize voices;
a microphone configured to record a conversation upon recognition of voices by the voice recognition circuit;
a conversation processing circuit configured to analyze information of the recorded conversation;
a calendar querying circuit configured to query the appointment storage based on an output of the conversation processing circuit; and
a feedback circuit configured to provide feedback to a user of the calendar management device based on an output of the calendar querying circuit.

2. The calendar management device of claim 1,
wherein the information related to the at least one appointment comprises time information for the at least one appointment.

3. The calendar management device of claim 1,
wherein the recorded conversation comprises at least one of a spoken conversation or a written conversation.

4. The calendar management device of claim 1,
wherein the conversation processing circuit comprises the microphone.

5. The calendar management device of claim 1,
wherein the conversation processing circuit is configured to determine whether the recorded conversation comprises a pre-determined keyword.

6. The calendar management device of claim 1,
wherein the conversation processing circuit is configured to determine whether the recorded conversation comprises a request for an appointment.

7. The calendar management device of claim 6,
wherein the conversation processing circuit is configured to determine whether the recorded conversation comprises time information related to the request for the appointment.

8. The calendar management device of claim 7,
wherein the calendar querying circuit is configured to determine whether the appointment storage comprises an appointment at least partially overlapping with the time information related to the request for the appointment.

9. The calendar management device of claim 8,
wherein the feedback circuit is configured to provide feedback indicating at least one of approval of the request for the appointment if the calendar querying circuit determines that the appointment storage does not comprise an appointment at least partially overlapping with the time information related to the request for the appointment, or an alternative timing if the calendar querying circuit determines that the appointment storage comprises an appointment at least partially overlapping with the time information related to the request for the appointment.

10. (canceled)

11. The calendar management device of claim 1,
wherein the feedback circuit is configured to provide at least one of visual feedback or acoustic feedback.

12. The calendar management device of claim 1,
wherein the calendar management device comprises a wearable device.

13. The calendar management device of claim 12,
wherein the wearable device comprises at least one of a wristband or a mobile radio communication device.

14. The calendar management device of claim 1,
wherein the appointment storage is configured to store information related to at least one appointment received from a radio communication device.

15. (canceled)

16. A method for controlling a calendar management device, the method comprising:
storing information related to at least one appointment in an appointment storage;
recognizing voices;
recording a conversation upon recognition of voices;
analyzing information of the recorded conversation;
querying the appointment storage based on the analyzing; and
providing feedback to a user of the calendar management device based on the querying.

17. (canceled)

18. (canceled)

19. The method of claim 16,
wherein the recorded conversation is analyzed based on an output of a microphone.

20. The method of claim 16, further comprising:
determining at least one of whether the recorded conversation comprises a pre-determined keyword, or whether the recorded conversation comprises a request for an appointment.

21. (canceled)

22. The method of claim 20, further comprising:
determining whether the recorded conversation comprises time information related to the request for the appointment.

23. The method of claim 22, further comprising:
determining whether the appointment storage comprises an appointment at least partially overlapping with the time information related to the request for the appointment.

24. The method of claim 23, further comprising:
providing feedback indicating at least one of approval of the request for the appointment if it is determined that the appointment storage does not comprise an appointment at least partially overlapping with the time information related to the request for the appointment, or an alternative timing if it is determined that the appointment storage comprises an appointment at least partially overlapping with the time information related to the request for the appointment.

25. (canceled)

26. The method of claim 16, further comprising:
providing at least one of visual feedback or acoustic feedback.

27. (canceled)

28. (canceled)

29. (canceled)

30. (canceled)
